(19) United States
(12) Patent Application Publication
(10) Pub. No.: US 2010/0071517 A1
(43) Pub. Date: Mar. 25, 2010

(54) ROTARY TOOL WITH INDICATING ELEMENT

(76) Inventor: Ji-Fen Meng, Tali City (TW)

Correspondence Address: Chien-Hui Su, P. O. Box 70-121 Taichung, Taichung City, 40899, TW

(21) Appl. No.: 12/238,432

(22) Filed: Sep. 25, 2008

(51) Int. Cl. B25B 23/00

(52) U.S. Cl. 81/180.1

(57) ABSTRACT

A rotary tool includes a body having an operating end thereon and an annular groove defined in an outer periphery of the body. An indicating element is stably received in the annular groove for indicating a standard of the rotary tool. The indicating element is an electric element for easily mounted into the annular groove.

### BACKGROUND OF THE INVENTION

1. Field of the Invention

The present invention relates to a rotary tool, and more particularly to a rotary tool with an indicating element for indicating the standard thereof.

2. Description of Related Art

Rotary tools, such as a screw driver bit or a socket, are often used for tightening/loosing a bolt or a screw. However, bolts and screws have various standards for providing different torsion. As a result, rotary tools with different standards are necessary such that an indicating element is necessary for user to quickly choose a rotary tool with a suitable standard.

A conventional indicating element for rotary tool in accordance with the prior art is made of plastic and sleeved on the rotary tool. The conventional indicating elements have different colors for providing the differentiating function among the rotary tools.

Another conventional indicating element for rotary tool in accordance with the prior art has a ring structure and is made of metal, such as aluminum alloy or iron. These metal rings have different colors for providing the differentiating function among the rotary tools.

However, the plastic ring has a weak structure and is sleeved in the rotary tool such that the plastic ring may be easily broken after being used for a period of time.

In addition, the metal ring has a strong structure. However, the metal ring is hard to be sleeved on the rotary tool such that the metal ring is inconvenient for being used as an indicating element which is sleeved on the rotary tool.

The present invention has arisen to mitigate and/or obviate the disadvantages of the conventional indicating elements for rotary tools.

### SUMMARY OF THE INVENTION

The main objective of the present invention is to provide an improved rotary tool with an indicating element that is easily mounted on the rotary tool.

To achieve the objective, the rotary tool in accordance with the present invention comprises a body having an operating end thereon and an annular groove defined in an outer periphery of the body. An indicating element is stably received in the annular groove for indicating a standard of the rotary tool. The indicating element is an electric element for easily mounted into the annular groove. The indicating element has a colored indicating mark formed thereon for indicating the standard of the rotary tool and the indicating element is a metal spring for lengthening the lifetime thereof.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a rotary tool with an indicating element in accordance with the present invention;

FIG. 2 is a perspective view of a rotary tool in accordance with the present invention;

FIG. 3 is a perspective view for showing the serial rotary tools with serial indicating elements;

FIG. 4 is a side plan view of a second embodiment of a rotary tool with an indicating element in accordance with the present invention; and

FIG. 5 is a side plan view of a third embodiment of a rotary tool with an indicating element in accordance with the present invention.

### DETAILED DESCRIPTION OF THE INVENTION

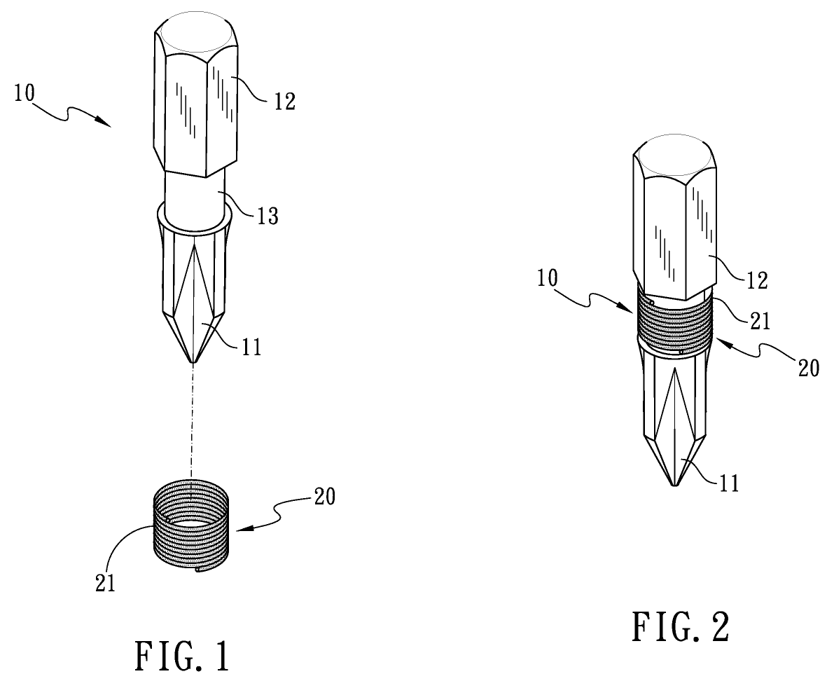

Referring to the drawings and initially to FIGS. 1 and 2, a rotary tool (10), which is illustrated with a screw driver bit, in accordance with the present invention comprises a polygonal shank (12) having an operating end (11) formed thereon. The operating end (11) is flat-type or Phillips-type for the screws with different types. An annular groove (13) is defined near a middle of the shank (12) and an indicating element (20) is stably received in the annular groove (13) for indicating the standard of the rotary tool (10).

The indicating element (20) is an elastic element and has a ring structure. In the preferred embodiment of the present invention, the indicating element (20) is a metal spring such that the indicating element (20) can be easily mounted into the annular groove (13). In addition, the indicating element (20) is stably received in the annular groove (13) such that the indicating element (20) should not be detached from the shank (12) and the indicating element (20) is made of metal material such that the indicating element (20) is hard to be broken.

The indicating element (20) has an indicating mark (21) formed thereon. In the preferred embodiment of the present invention, the indicating mark (21) is color. The indicating marks (21) of different indicating elements (20) provide differentiating effect by using different colors.

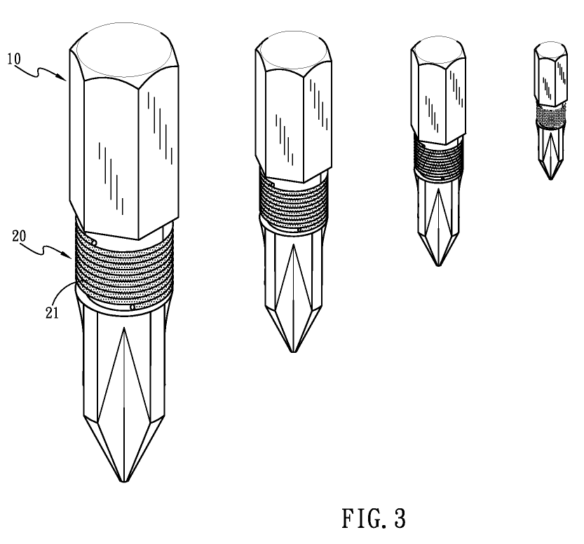

With reference to FIG. 3, the indicating marks (21) of the indicating elements (20) have same color and indicating elements (20) are respectively sleeved on serial screw driver bits. In this embodiment, the indicating marks (21) indicate different standards by the color gradient thereof. In addition, the indicating element (20) is made of metal material such that the lifetime of the indicating element is lengthened.

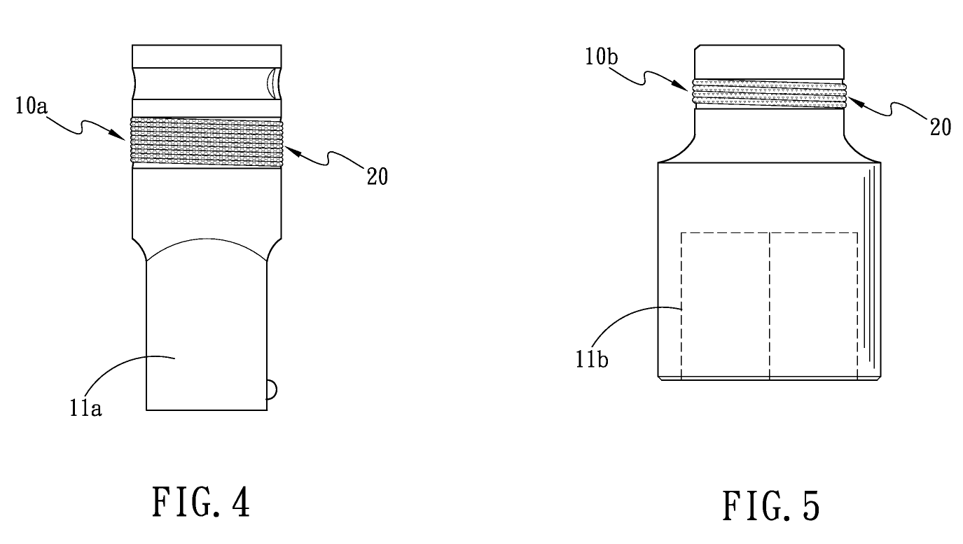

With reference to FIG. 4 that show a second embodiment of the rotary tool in accordance with the present invention, in this embodiment, the rotary tool (10a) is a socket and the operating end (11a) is formed with a polygonal stub for partially received in a head of a bolt.

With reference to FIG. 5 that show a third embodiment of the rotary on accordance with the present invention, in this embodiment, the rotary tool (10b) is a socket and the operating end (11b) has a polygonal hole longitudinally defined therein for receiving a head of a bolt.

Although the invention has been explained in relation to its preferred embodiment, it is to be understood that many other possible modifications and variations can be made without departing from the spirit and scope of the invention as hereinafter claimed.

1. A rotary tool comprising:
a body having an operating end formed thereon and an annular groove defined in an outer periphery of the body; and
an indicating element stably received in the annular groove, the indicating element having a colored indicating mark formed thereon for indicating a standard of the rotary tool, the indicating element being a metal spring, the metal spring being elastic for easily mounted into the annular groove, whereby when the metal spring is received in the annular groove, the metal spring being hard to be broken, a lifetime of the metal spring being lengthened.

2. The rotary tool as claimed in claim 1, wherein the body is a polygonal shank and the annular groove is defined in a middle thereof.

3. (canceled)

4. (canceled)

5. The rotary tool as claimed in claim 1, wherein the body is a screw driver bit.

6. The rotary tool as claimed in claim 1, wherein the body is socket.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)
